(19) United States
(12) Patent Application Publication
(10) Pub. No.: US 2016/0239394 A1
(43) Pub. Date: Aug. 18, 2016

(54) METHODS FOR IMPROVING MANAGEMENT OF INPUT OR OUTPUT OPERATIONS IN A NETWORK STORAGE ENVIRONMENT WITH A FAILURE AND DEVICES THEREOF

(71) Applicant: NetApp, Inc., Sunnyvale, CA (US)

(72) Inventors: Venkata Ramprasad Darisa, Kadapa (IN); Nandakumar Ravindranath Allu, Madurai (IN); Rajesh Nagarajan, Chennai (IN)

(21) Appl. No.: 14/622,014

(22) Filed: Feb. 13, 2015

(51) Int. Cl. G06F 11/20; G06F 11/07; G06F 11/14

(52) U.S. Cl. CPC G06F 11/2069; G06F 11/1423; G06F 11/0793; G06F 2201/85; G06F 2201/84

(57) ABSTRACT

This technology identifies one or more nodes with a failure, designates the identified one or more nodes as ineligible to service any I/O operation, and disables I/O ports of the identified one or more nodes. Another one or more nodes are selected to service any I/O operation of the identified one or more nodes based on a stored failover policy. Any of the I/O operations are directed to the selected another one or more nodes for servicing and then routing of any of the serviced I/O operations via a switch to the identified one or more nodes to execute any of the routed I/O operations with a storage device. An identification is made when the identified one or more nodes is repaired. The designation as ineligible is removed and one or more I/O ports of the identified one or more nodes are enabled when the repair is identified.

### FIELD

This technology generally relates to methods and devices for network storage and, more particularly, to methods for improving management of input or output (I/O) operations in a network storage environment with a failure and devices thereof.

### BACKGROUND

When one of a cluster of node controller computing devices in a network storage environment serving any input or output (I/O) operation and experiences a failure, such as a NVRAM battery failure, data loss can occur. To avoid data loss or other interruption, some network storage environments comprise a cluster of pairs of high availability node controller computing devices. As a result, if one of the high availability node controller computing devices in a pair experiences the failure, then the other high availability mode controller computing device in the pair is able to service any I/O operation for the storage owned by the one of the high availability mode controller computing devices which experienced the failure. Unfortunately, in other examples prior network storage environments have not been configured to be able to avoid data loss or other interruption.

For example, in the example described above if both of the high availability mode controller computing devices in a pair experienced the failure, then all storage owned by those devices will lose data serving capabilities. This occurs because both of those devices in the pair will need to be shutdown for repairs with no way to service any I/O operation in the interim.

In another example, a network storage environment may comprise a cluster of non-high availability mode controller computing device. In this example, if one of the non-high availability mode controller computing devices experienced a failure, then that non-high availability mode controller computing device will need to shut down for repairs and also will experience a data loss during this outage.

### SUMMARY

A method for improving management of input or output (I/O) operations in a network storage environment with a failure includes identifying, by at least one of a plurality of node controller computing devices, another one of the plurality of node controller computing devices with a failure. The identified one of the plurality of node controller computing devices with the failure is designated, by the at least one of the plurality of node controller computing devices, as ineligible to service any I/O operation. Additionally, one or more I/O ports of the identified one of the plurality of node controller computing devices with the failure are disabled, by the at least one of the plurality of node controller computing devices. Another one of the plurality of node controller computing devices without a failure is selected, by the at least one of the plurality of node controller computing devices, to service any I/O operation of the identified one of the plurality of node controller computing devices with the failure based on a stored failover policy. Any of the I/O operations are directed, by the at least one of the plurality of node controller computing devices, to the selected another one of the plurality of node controller computing devices for servicing. Next, any of the serviced I/O operations are routed, by the at least one of the plurality of node controller computing devices, via a switch to the identified one of the plurality of node controller computing devices with the failure to execute any of the routed I/O operations with a storage device. An identification is made, by the at least one of the plurality of node controller computing devices, when the identified one of the plurality of node controller computing devices with the failure is repaired. Next, the designation as ineligible is removed and one or more I/O ports of the identified one of the plurality of node controller computing devices identified with the repair are enabled, by the at least one of the plurality of node controller computing devices.

A non-transitory computer readable medium having stored thereon instructions for improving management of input or output (I/O) operations in a network storage environment with a failure comprising executable code which when executed by a processor, causes the processor to perform steps including identifying one of a plurality of node controller computing devices with a failure. The identified one of the plurality of node controller computing devices with the failure is designated as ineligible to service any I/O operation. Additionally, one or more I/O ports of the identified one of the plurality of node controller computing devices with the failure are disabled. Another one of the plurality of node controller computing devices is selected to service any I/O operation of the identified one of the plurality of node controller computing devices with the failure based on a stored failover policy. Any of the I/O operations are directed to the selected another one of the plurality of node controller computing devices for servicing. Next, any of the serviced I/O operations are routed via a switch to the identified one of the plurality of node controller computing devices with the failure to execute any of the routed I/O operations with a storage device. An identification is made when the identified one of the one the plurality of node controller computing devices with the failure is repaired. Next, the designation as ineligible is removed and one or more I/O ports of the identified one of the plurality of node controller computing devices identified with the repair are enabled.

A network storage management system comprising a plurality of node controller computing devices, wherein one or more of the plurality of node controller computing devices comprise a memory coupled to a processor which is configured to be capable of executing programmed instructions comprising and stored in the memory to identify one of a plurality of node controller computing devices with a failure. The identified one of the plurality of node controller computing devices with the failure is designated as ineligible to service any I/O operation. Additionally, one or more I/O ports of the identified one of the plurality of node controller computing devices with the failure are disabled. Another one of the plurality of node controller computing devices without a failure is selected to service any I/O operation of the identified one of the plurality of node controller computing devices with the failure based on a stored failover policy. Any of the I/O operations are directed to the selected another one of the plurality of node controller computing devices for servicing. Next, any of the serviced I/O operations are routed via a switch to the identified one of the plurality of node controller computing devices with the failure to execute any of the routed I/O operations with a storage device. An identification is made when the identified one of the plurality of node controller computing devices with the failure is repaired. Next, the designation as ineligible is removed and one or more I/O ports of the identified one of the plurality of node controller computing devices identified with the repair are enabled.

This technology provides a number of advantages including providing methods, non-transitory computer readable media and devices that improve management of input or output operations in a network storage environment with a failure. With this technology the amount of data loss and/or data corruption which may previously have occurred during a failure is minimized and in some instance eliminated. Additionally, with this technology the need to turn off service of any I/O operation to any storage is also minimized and in some instances eliminated.

### BRIEF DESCRIPTION OF THE DRAWINGS

FIG. 1 is a block diagram of an environment with an example of a network storage environment with a network storage management system comprising a plurality of node controller computing devices that improves management of a failure;

FIG. 2 is a block diagram of the example of one of the plurality of node controller computing devices shown in FIG. 1;

FIG. 3 is a flow chart of an example of a method for improving management of input or output operations in a network storage environment with a high availability pair of node controller computing devices with a failure; and

FIG. 4 is a flow chart of an example of a method for improving management of input or output operations in a network storage environment with a non-high availability node controller computing device with a failure.

### DETAILED DESCRIPTION

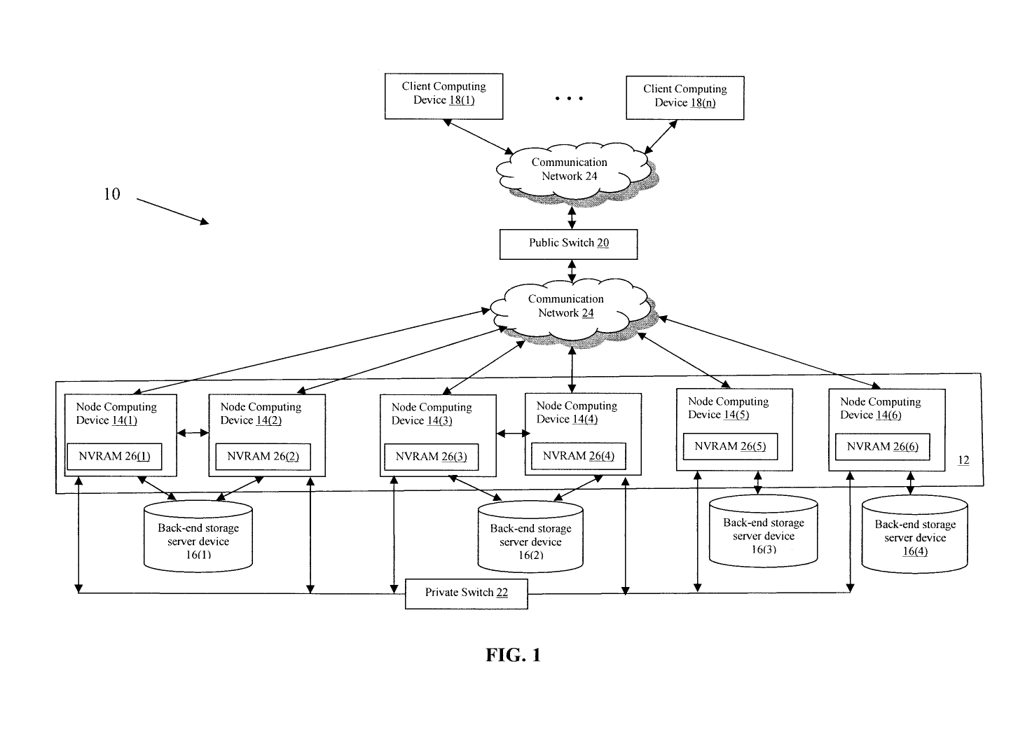

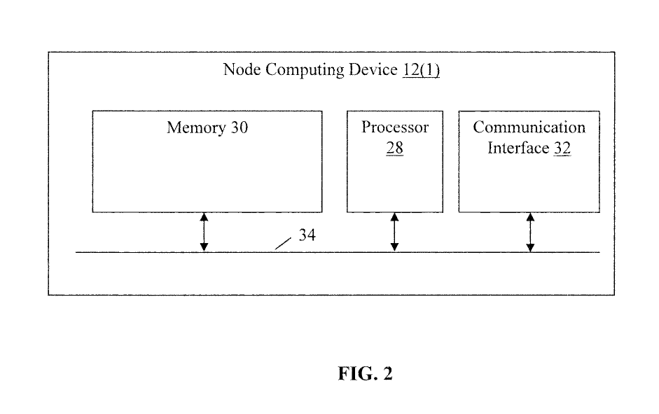

An example of a network storage environment 10 with a network storage management system 12 comprising a plurality node controller computing devices 14(1)-14(n) is illustrated in FIGS. 1-2. In this particular example, the environment 10 includes the network storage management system 12 with the node controller computing devices or nodes 14(1)-14(n), back-end storage server devices 16(1)-16(4), client computing devices 18(1)-18(n), public switch 20, and private switch 22 coupled via one or more communication networks 24, although the environment 10 and/or the network storage management system 12 could include other types and numbers of systems, devices, components, and/or other elements as is generally known in the art and will not be illustrated or described herein. The environment 10 may include other network devices such as one or more routers and/or switches, for example. This technology provides a number of advantages including providing methods, non-transitory computer readable media and devices that improve management of input or output operations in a network storage environment with a failure.

Referring more specifically to FIGS. 1-2, each of the node controller computing devices 14(1)-14(n) in the network storage management system 12 may be configured to be capable to manage service of input or output (I/O) operations between the back-end storage server devices 16(1)-16(4) and the client computing devices 18(1)-18(n) and improve management of input or output operations when a failure occurs in the network storage environment 10 by way of example only, although each could perform other types and/or numbers of other operations. Additionally, in this particular example each of the node controller computing devices 14(1)-14(n) in the network storage management system 12 represent physical machines used to manage these I/O operations, although other configurations, such as a virtual network with virtual machines implementing one or more of the node controller computing devices 14(1)-14(n) could be used by way of example only.

In this particular example, each of the node controller computing devices 14(1)-14(n) includes a processor 24, a memory 26, and a communication interface 28 which are coupled together by a bus 30, although each of the node controller computing devices 14(1)-14(n) may include other types and/or numbers of physical and/or virtual systems, devices, components, and/or other elements in other configurations. For ease of illustration, only the node management computing device 12 is illustrated in FIG. 2, although in this particular example each of the other the node controller computing devices 14(1)-14(n) have the same structure and operation except as other illustrated or described herein.

The processor 24 of in each of the node controller computing devices 14(1)-14(n) may execute one or more programmed instructions stored in the memory 26 for improving management of a failure in a network storage environment as illustrated and described in the examples herein, although other types and numbers of functions and/or other operation can be performed. The processor 24 of in each of the node controller computing devices 14(1)-14(n) may include one or more central processing units and/or general purpose processors with one or more processing cores, for example.

The memory 26 of in each of the node controller computing devices 14(1)-14(n) stores the programmed instructions and other data for one or more aspects of the present technology as described and illustrated herein, although some or all of the programmed instructions could be stored and executed elsewhere. A variety of different types of memory storage devices, such as a random access memory (RAM) or a read only memory (ROM) in the system or a floppy disk, hard disk, CD ROM, DVD ROM, or other computer readable medium which is read from and written to by a magnetic, optical, or other reading and writing system that is coupled to the processor 24, can be used for the memory 26. In this particular example, the memory 26 in each of the node controller computing devices 14(1)-14(n) further includes a corresponding one of the NVRAMs 26(1)-26(6), although each memory could comprise other types and/or numbers of systems, devices, components, and/or elements.

The communication interface 28 of in each of the node controller computing devices 14(1)-14(n) operatively couples and communicates between each other and also one or more of the back-end storage server devices 16(1)-16(n) and one or more of the client computing devices 18(1)-18(n) which are all coupled together by the public switch 20, the private switch 22, and/or one or more of the communication networks 24, although other types and numbers of communication networks or systems with other types and numbers of connections and configurations to other devices and elements. By way of example only, the communication networks 24 can use TCP/IP over Ethernet and industry-standard protocols, including NFS, CIFS, SOAP, XML, LDAP, SCSI, and SNMP, although other types and numbers of communication networks, can be used. The communication networks 24 in this example may employ any suitable interface mechanisms and network communication technologies, including, for example, any local area network, any wide area network (e.g., Internet), teletraffic in any suitable form (e.g., voice, modem, and the like), Public Switched Telephone Network (PSTNs), Ethernet-based Packet Data Networks (PDNs), and any combinations thereof and the like.

In this particular example, each of the client computing devices 18(1)-18(n) may run applications that may provide an interface to make requests for and receive content hosted by one or more of the back-end storage server devices 16(1)-16(n) via one or more of the node controller computing devices 14(1)-14(n).

The back-end storage server devices 16(1)-16(n) may store and provide content or other network resources in response to requests from the client computing devices 18(1)-18(n) via the public switch 20, the private switch 22, and/or one or more of the communication networks 24, for example, although other types and numbers of storage media in other configurations could be used. In particular, the back-end storage server devices 16(1)-16(n) may each comprise various combinations and types of storage hardware and/or software and represent a system with multiple network server devices in a data storage pool, which may include internal or external networks. Various network processing applications, such as CIFS applications, NFS applications, HTTP Web Network server device applications, and/or FTP applications, may be operating on the back-end storage server devices 16(1)-16(n) and transmitting data (e.g., files or web pages) in response to requests from the client computing devices 18(1)-18(n).

Each of the back-end storage server devices 16(1)-16(n) and each of the client computing devices 18(1)-18(n) may include a processor, a memory, and a communication interface, which are coupled together by a bus or other link, although other numbers and types of devices and/or nodes as well as other network elements could be used.

Although the exemplary network environment 10 with the network storage management system 12 with the node controller computing devices 14(1)-14(n), back-end storage server devices 16(1)-16(4), client computing devices 18(1)-18(n), public switch 20, and private switch 22 and the communication networks 24 are described and illustrated herein, other types and numbers of systems, devices, components, and elements in other topologies can be used. It is to be understood that the systems of the examples described herein are for exemplary purposes, as many variations of the specific hardware and software used to implement the examples are possible, as will be appreciated by those skilled in the relevant art(s).

In addition, two or more computing systems or devices can be substituted for any one of the systems or devices in any example. Accordingly, principles and advantages of distributed processing, such as redundancy and replication also can be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic media, wireless traffic networks, cellular traffic networks, G3 traffic networks, Public Switched Telephone Network (PSTNs), Packet Data Networks (PDNs), the Internet, intranets, and combinations thereof.

The examples also may be embodied as a non-transitory computer readable medium having instructions stored thereon for one or more aspects of the present technology as described and illustrated by way of the examples herein, as described herein, which when executed by the processor, cause the processor to carry out the steps necessary to implement the methods of this technology as described and illustrated with the examples herein.

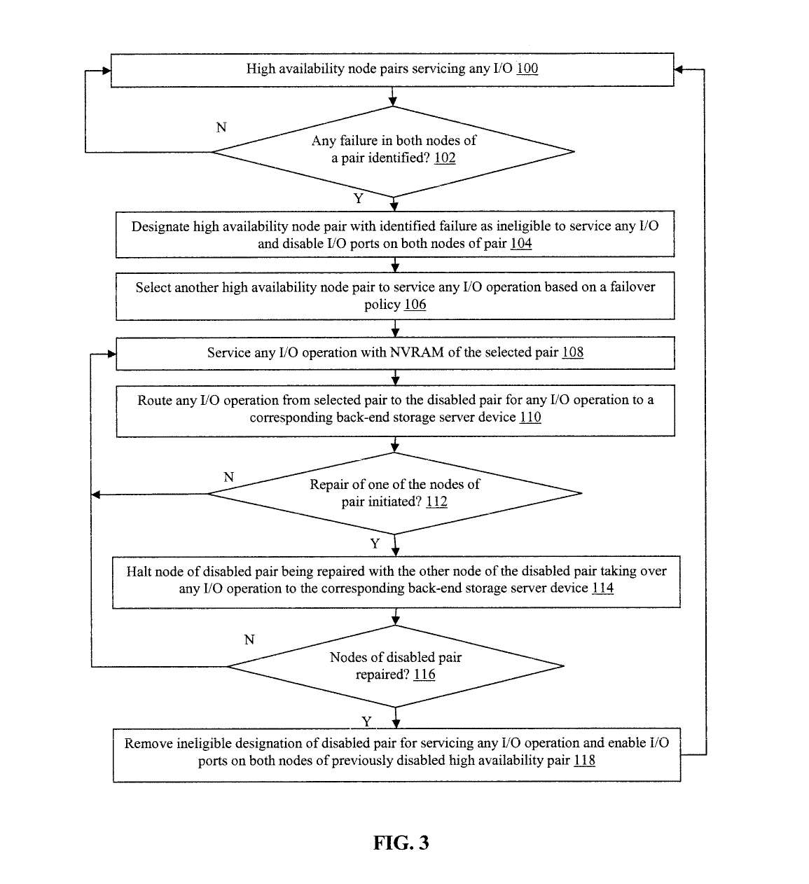

An example of a method for improving management of input or output operations in a network storage environment 10 with one of two pairs of high availability node controller computing devices 14(1)-14(2) and 14(3)-14(4) with a failure will now be illustrated and described with reference to FIGS. 1-3, although the network storage environment 10 can comprise other types and/or numbers of high availability pairs and/or non-high-availability node controller computing devices.

In step 100, the pairs of high availability node controller computing devices 14(1)-14(2) and 14(3)-14(4) are each servicing any input or output (I/O) operation between any of the back-end storage devices 16(1)-16(2) and the client computing devices 18(1)-18(n), although the I/O operations could be between other systems, devices, components and/or other elements.

In step 102, the pairs of high availability node controller computing devices 14(1)-14(2) and 14(3)-14(4) monitor a corresponding status of each of the pairs of high availability node controller computing devices 14(1)-14(2) and 14(3)-14(4) to identify a failure in both of the node controller computing devices in the pair 14(1)-14(2) or the pair 14(3)-14(4), although other approaches for identifying the failure in both of the node controller computing devices in the pair 14(1)-14(2) or the pair 14(3)-14(4) could be used. For example, one or more of the node controller computing devices 14(1)-14(4) could be configured to be capable of monitoring a status of the other node controller computing devices 14(1)-14(4) to identify a failure by way of example only.

If in step 102, neither of the pairs of high availability node controller computing devices 14(1)-14(2) and 14(3)-14(4) identify a failure in both of the node controller computing devices in the pair 14(1)-14(2) or in the pair 14(3)-14(4), e.g. there is no failure detected or only one of the node controller computing devices in a pair 14(1)-14(2) or 14(3)-14(4) has a failure, then the No branch is taken back to step 100 where the pairs of high availability node controller computing devices 14(1)-14(2) and 14(3)-14(4) continue to service any I/O operations.

If in step 102, one of the pairs of high availability node controller computing devices 14(1)-14(2) and 14(3)-14(4) does identify a failure in both of the node controller computing devices in the pair 14(1)-14(2) or in the pair 14(3)-14(4), then the Yes branch is taken to step 104. For purposes of illustration only, for this particular example a failure in both of the node controller computing devices in the pair 14(1)-14(2), such as an impending NVRAM battery failure, has been identified, although other types of failures could be identified.

In step 104, the pair of high availability node controller computing devices 14(3)-14(4) marks the pair of high availability node controller computing devices 14(1)-14(2) identified as both having a failure in this particular example as ineligible to serve I/O due to an impending data loss situation and disables the input and output (10) ports to the pair of high availability node controller computing devices 14(1)-14(2).

In step 106, the pair of high availability node controller computing devices 14(3)-14(4) implements a failover of the I/O ports of the pair of high availability node controller computing devices 14(1)-14(2) to the I/O ports of the pair of high availability node controller computing devices 14(3)-14(4) based on a stored configuration of a failover policy, although other types of approaches for determining the failover of the disabled I/O ports could be used.

In step 108, the pair of high availability node controller computing devices 14(3)-14(4) directs any I/O operations for the pair of high availability node controller computing devices 14(1)-14(2) will first be written to the NVRAM 26(3) and/or NVRAM 26(4) of the pair of high availability node controller computing devices 14(3)-14(4).

In step 110, the pair of high availability node controller computing devices 14(3)-14(4) route the one or more serviced I/O operations via the private switch 22 to the pair of high availability node controller computing devices 14(1)-14(2) which are then written to the back-end storage device 16(1) comprising a disk tray in this example.

In step 112, the node management computing device 12 determines when a repair to one of the pair of high availability node controller computing devices 14(1)-14(2) is initiated. By way of example only, the node management computing device 12 may receive an indication that a NVRAM battery is available for replacement in one of the node controller computing devices in the pair of high availability node controller computing devices 14(1)-14(2), although other approaches for determining when a repair will be initiated can be used. If in step 112, the pair of high availability node controller computing devices 14(3)-14(4) determines a repair to one of the node controller computing devices in the pair of high availability node controller computing devices 14(1)-14(2) has not been initiated, then the No branch is taken back to step 108 as described earlier. If in step 112, the pair of high availability node controller computing devices 14(3)-14(4) determines a repair to one of the node controller computing devices in the pair of high availability node controller computing devices 14(1)-14(2) has been initiated, then the Yes branch is taken to step 114.

In step 114, the pair of high availability node controller computing devices 14(3)-14(4) halts operation in the one of the node controller computing devices in the pair of high availability node controller computing devices 14(1)-14(2) being repaired, e.g. a NVRAM batter replacement, and directs the other one of the node controller computing devices in the pair of high availability node controller computing devices 14(1)-14(2) to take over write operations routed by the private switch 22 to the back-end storage device 16(1).

In step 116, the pair of high availability node controller computing devices 14(3)-14(4) determines when both of the high availability node controller computing devices 14(1)-14(2) have been repaired. If the pair of high availability node controller computing devices 14(3)-14(4) determines both of the high availability node controller computing devices 14(1)-14(2) have not been repaired, then the No branch is taken back to step 108. For example, if neither of or only one of the node controller computing devices in the pair of high availability node controller computing devices 14(1)-14(2) have been repaired, then the No branch is taken back to step 108. If the pair of high availability node controller computing devices 14(3)-14(4) determines both of the high availability node controller computing devices 14(1)-14(2) have been repaired, then the Yes branch is taken to step 118.

In step 118, the pair of high availability node controller computing devices 14(3)-14(4) removes the designation as ineligible and enables the I/O ports of the node controller computing devices in the pair of high availability node controller computing devices 14(1)-14(2) and then may return to step 100.

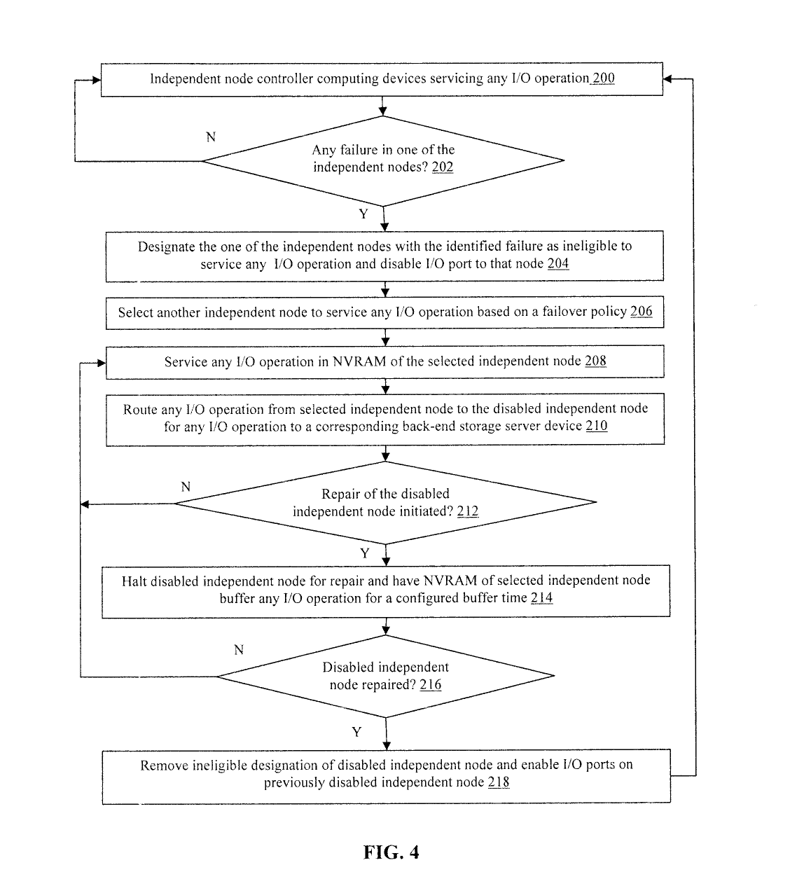

Another example of a method for improving management of input or output operations in a network storage environment 10 with one of two non-high availability or independent node controller computing devices 14(5) and 14(6) experiencing a failure will now be illustrated and described with reference to FIGS. 1-2 and 4, although the network storage environment 10 can comprise other types and/or numbers of high availability pairs and/or non-high-availability or independent node controller computing devices.

In step 200, the independent node controller computing devices 14(5) and 14(6) are each servicing any input or output (I/O) operation between any of the back-end storage devices 16(3)-16(4) and the client computing devices 18(1)-18(n), although the I/O operations could be between other systems, devices, components and/or other elements.

In step 202, each of the independent node controller computing devices 14(5) and 14(6) monitors a corresponding status of each of the independent node controller computing devices 14(5) and 14(6) to identify a failure in one of the independent node controller computing devices 14(5) and 14(6), although other approaches for identifying the failure could be used.

If in step 202, neither of the independent node controller computing devices 14(5) and 14(6) identify a failure in one of the independent node controller computing devices 14(5) and 14(6), then the No branch is taken back to step 200 where the independent node controller computing devices 14(5) and 14(6) continue to service any I/O operations.

If in step 202, one of the independent node controller computing devices 14(5) and 14(6) does identify a failure in another one of the independent node controller computing devices 14(5) and 14(6), then the Yes branch is taken to step 204. For purposes of illustration only, for this particular example a failure in independent node controller computing device 14(5), such as an impending NVRAM battery failure, has been identified, although other types of failures could be identified.

In step 204, the independent node controller computing device 14(6) marks the independent node controller computing device 14(5) identified as having a failure in this particular example as ineligible to serve I/O due to an impending data loss situation and disables the input and output (IC)) ports to the independent node controller computing device 14(5).

In step 206, the independent node controller computing device 14(6) the implements a failover of the I/O ports of the independent node controller computing device 14(5) to the I/O ports of the independent node controller computing device 14(6) based on a stored configuration of a failover policy, although other types of approaches for determining the failover of the disabled I/O ports could be used.

In step 208, the independent node controller computing device 14(6) directs any I/O operations for the independent node controller computing device 14(5) will first be written to the NVRAM 26(6) of the independent node controller computing device 14(6).

In step 210, the independent node controller computing device 14(6) directs the routing of the one or more serviced I/O operations via the private switch 22 to the independent node controller computing device 14(5) which is then written to the back-end storage device 16(5) comprising a disk tray in this example.

In step 212, the independent node controller computing device 14(6) determines when a repair to independent node controller computing device 14(5) is initiated. By way of example only, the independent node controller computing device 14(6) may receive an indication that a NVRAM battery is available for replacement in the independent node controller computing device 14(5), although other approaches for determining when a repair will be initiated can be used. If in step 212, the independent node controller computing device 14(6) determines a repair to the independent node controller computing device 14(5) has not been initiated, then the No branch is taken back to step 208 as described earlier. If in step 212, the independent node controller computing device 14(6) determines a repair to independent node controller computing device 14(5) has been initiated, then the Yes branch is taken to step 214.

In step 214, the independent node controller computing device 14(6) halts operation in the independent node controller computing device 14(5) being repaired, e.g. a NVRAM batter replacement and buffers directs the independent node controller computing device 14(6) to buffer any of the I/O operations for a stored buffer period of time.

In step 216, the independent node controller computing device 14(6) determines when the independent node controller computing device 14(5) has been repaired. If the independent node controller computing device 14(6) determines the independent node controller computing device 14(5) has not been repaired, then the No branch is taken back to step 208. If the independent node controller computing device 14(6) determines the independent node controller computing device 14(5) has been repaired, then the Yes branch is taken to step 218.

In step 218, the independent node controller computing device 14(6) removes the designation as ineligible and enables the I/O ports of the independent node controller computing device 14(5) and then may return to step 200.

Accordingly as illustrated and described by way of the examples herein, this technology provides a number of advantages including providing methods, non-transitory computer readable media and devices that improve management of input or output operations in a network storage environment with a failure. With this technology the amount of data loss and/or data corruption which may previously have occurred during a failure is minimized and in some instance eliminated. Additionally, with this technology the need to turn off service of any I/O operation to any storage is also minimized and in some instances eliminated.

Having thus described the basic concept of this technology, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of this technology. Additionally, the recited order of processing elements or sequences, or the use of numbers, letters, or other designations therefore, is not intended to limit the claimed processes to any order except as may be specified in the claims. Accordingly, this technology is limited only by the following claims and equivalents thereto.

What is claimed is:

1. A method for improving management of input or output (I/O) operations in a network storage environment with a failure, the method comprising:
identifying, by at least one of a plurality of node controller computing devices, another one of the plurality of node controller computing devices with a failure;
designating, by the at least one of the plurality of node controller computing devices, as ineligible to service any I/O operation and disabling one or more I/O ports of the identified one of the plurality of node controller computing devices with the failure;
selecting, by the at least one of the plurality of node controller computing devices, another one of the plurality of node controller computing devices without a failure to service any I/O operation of the identified one of the plurality of node controller computing devices with the failure based on a stored failover policy;
directing, by the at least one of the plurality of node controller computing devices, any of the I/O operations to the selected another one of the plurality of node controller computing devices for servicing and then routing of any of the serviced I/O operations via a switch to the identified one of the plurality of node controller computing devices with the failure to execute any of the routed I/O operations with a storage device;
identifying, by the at least one of the plurality of node controller computing devices, when the identified one of the plurality of node controller computing devices with the failure is repaired; and
removing, by the at least one of the plurality of node controller computing devices, the designation as ineligible and enabling one or more I/O ports of the identified one of the plurality of node controller computing devices identified with the repair.

2. The method as set forth in claim 1 wherein the identified one of the plurality of node controller computing devices with the failure further comprises two of the plurality of node controller computing devices in a pair with the failure; and
wherein the selecting another one of the plurality of node controller computing devices without a failure further comprises:
selecting, by the at least one of the plurality of node controller computing devices, another pair of the plurality of node controller computing devices without a failure to service any I/O operation of the identified pair of the plurality of node controller computing devices with the failure based on the stored failover policy.

3. The method as set forth in claim 2 further comprising:
identifying, by the at least one of the plurality of node controller computing devices, when a repair of one of the two of the plurality of node controller computing devices in the pair with the failure is initiated;
wherein the directing any of the I/O operations to the selected another one of the plurality of node controller computing devices without a failure for servicing and then routing of any of the serviced I/O operations further comprises:
halting, by the at least one of the plurality of node controller computing devices, the servicing of any of the routed I/O operations with the one of the two of the plurality of node controller computing devices in a pair with the failure with the identified initation of the repair; and
allowing, by the at least one of the plurality of node controller computing devices, the other one of the two of the plurality of node controller computing devices in a pair with the failure which does not have the identified initation of the repair to take over the servicing of any of the routed I/O operations.

4. The method as set forth in claim 1 wherein the identified one of the plurality of node controller computing devices with the failure further comprises an independent node controller computing device in the plurality of node controller computing devices with the failure; and
wherein the selecting another one of the plurality of node controller computing devices without a failure further comprises:
selecting, by the at least one of the plurality of node controller computing devices, another independent one of the plurality of node controller computing devices without a failure to service any I/O operation of the identified independent one of the plurality of node controller computing devices with the failure based on the stored failover policy.

5. The method as set forth in claim 4 further comprising:
identifying, by the at least one of the plurality of node controller computing devices, when a repair of the identified independent one of the plurality of node controller computing devices with the failure is initiated;
wherein the directing any of the I/O operations to the selected another one of the plurality of node controller computing devices for servicing and then routing of any of the serviced I/O operations further comprises:
halting, by the at least one of the plurality of node controller computing devices, the servicing of any of the routed I/O operations with the identified independent one of the plurality of node controller computing devices with the failure and with the identified initation of the repair; and
allowing, by the at least one of the plurality of node controller computing devices, buffering of any of the routed I/O operations in the another independent one of the plurality of node controller computing devices for a stored buffer time.

6. The method as set forth in claim 1 wherein the failure comprises a failure of a NVRAM battery failure in one or more of the plurality of node controller computing devices.

7. A non-transitory computer readable medium having stored thereon instructions for improving management of input or output (I/O) operations in a network storage environment with a failure comprising executable code which when executed by a processor, causes the processor to perform steps comprising:
identifying one of the one or more of the plurality of node controller computing devices with a failure;
designating as ineligible to service any I/O operation and disabling one or more I/O ports of the identified one of the plurality of node controller computing devices with the failure;
selecting another one of the plurality of node controller computing devices without a failure to service any I/O operation of the identified one of the plurality of node controller computing devices with the failure based on a stored failover policy;
directing any of the I/O operations to the selected another one of the plurality of node controller computing devices for servicing and then routing of any of the serviced I/O operations via a switch to the identified one of the plurality of node controller computing devices with the failure to execute any of the routed I/O operations with a storage device;
identifying when the identified one of the plurality of node controller computing devices with the failure is repaired; and
removing the designation as ineligible and enabling one or more I/O ports of the identified one of the plurality of node controller computing devices identified with the repair.

8. The medium as set forth in claim 7 wherein the identified one of the plurality of node controller computing devices with the failure further comprises two of the plurality of node controller computing devices in a pair with the failure; and
wherein the selecting another one of the plurality of node controller computing devices without a failure further comprises:
selecting another pair of the plurality of node controller computing devices without a failure to service any I/O operation of the identified pair of the plurality of node controller computing devices with the failure based on the stored failover policy.

9. The medium as set forth in claim 8 further comprising:
identifying when a repair of one of the two of the plurality of node controller computing devices in the pair with the failure is initiated;
wherein the directing any of the I/O operations to the selected another one of the plurality of node controller computing devices without a failure for servicing and then routing of any of the serviced I/O operations further comprises:
halting the servicing of any of the routed I/O operations with the one of the two of the plurality of node controller computing devices in a pair with the failure with the identified initation of the repair; and
allowing the other one of the two of the plurality of node controller computing devices in a pair with the failure which does not have the identified initation of the repair to take over the servicing of any of the routed I/O operations.

10. The medium as set forth in claim 7 wherein the identified one of the plurality of node controller computing devices with the failure further comprises an independent node controller computing device in the plurality of node controller computing devices with the failure; and
wherein the selecting another one of the plurality of node controller computing devices without a failure further comprises:
selecting another independent one of the plurality of node controller computing devices without a failure to service any I/O operation of the identified independent one of the plurality of node controller computing devices with the failure based on the stored failover policy.

11. The medium as set forth in claim 10 further comprising:
identifying when a repair of the identified independent one of the plurality of node controller computing devices with the failure is initiated;
wherein the directing any of the I/O operations to the selected another one of the plurality of node controller computing devices for servicing and then routing of any of the serviced I/O operations further comprises:
halting the servicing of any of the routed I/O operations with the identified independent one of the plurality of node controller computing devices with the failure and with the identified initation of the repair; and
allowing buffering of any of the routed I/O operations in the another independent one of the plurality of node controller computing devices for a stored buffer time.

12. The medium as set forth in claim 7 wherein the failure comprises a failure of a NVRAM battery failure in one or more of the plurality of node controller computing devices.

13. A network storage management system comprising:
a plurality of node controller computing devices, wherein one or more of the plurality of node controller computing devices comprise a memory coupled to a processor which is configured to be capable of executing programmed instructions comprising and stored in the memory to:
identify one of the one or more of the plurality of node controller computing devices with a failure;
designate as ineligible to service any I/O operation and disabling one or more I/O ports of the identified one of the plurality of node controller computing devices with the failure;
select another one of the plurality of node controller computing devices without a failure to service any I/O operation of the identified one of the plurality of node controller computing devices with the failure based on a stored failover policy;
direct any of the I/O operations to the selected another one of the plurality of node controller computing devices for servicing and then routing of any of the serviced I/O operations via a switch to the identified one of the plurality of node controller computing devices with the failure to execute any of the routed I/O operations with a storage device;
identify when the identified one of the plurality of node controller computing devices with the failure is repaired; and
remove the designation as ineligible and enabling one or more I/O ports of the identified one of the plurality of node controller computing devices identified with the repair.

14. The system as set forth in claim 13 wherein the identified one of the plurality of node controller computing devices with the failure further comprises two of the plurality of node controller computing devices in a pair with the failure; and
wherein the processor coupled to the memory is further configured to be capable of executing at least one additional programmed instruction for the select another one of the plurality of node controller computing devices without a failure further comprises and is stored in the memory to:
select another pair of the plurality of node controller computing devices without a failure to service any I/O operation of the identified pair of the plurality of node controller computing devices with the failure based on the stored failover policy.

15. The system as set forth in claim 14 wherein the processor coupled to the memory is further configured to be capable of executing at least one additional programmed instruction further comprising and stored in the memory to:
identify when a repair of one of the two of the plurality of node controller computing devices in the pair with the failure is initiated;
wherein the processor coupled to the memory is further configured to be capable of executing at least one additional programmed instruction for the direct any of the I/O operations to the selected another one of the plurality of node controller computing devices without a failure for servicing and then routing of any of the serviced I/O operations further comprising and stored in the memory to:
halt the servicing of any of the routed I/O operations with the one of the two of the plurality of node controller computing devices in a pair with the failure with the identified initation of the repair; and
allow the other one of the two of the plurality of node controller computing devices in a pair with the failure which does not have the identified initation of the repair to take over the servicing of any of the routed I/O operations.

16. The system as set forth in claim 13 wherein the identified one of the plurality of node controller computing devices with the failure further comprises an independent node controller computing device in the plurality of node controller computing devices with the failure; and
wherein the processor coupled to the memory is further configured to be capable of executing at least one additional programmed instruction for the select another one of the plurality of node controller computing devices without a failure further comprising and stored in the memory to:
select another independent one of the plurality of node controller computing devices without a failure to service any I/O operation of the identified independent one of the plurality of node controller computing devices with the failure based on the stored failover policy.

17. The system as set forth in claim 16 wherein the processor coupled to the memory is further configured to be capable of executing at least one additional programmed instruction further comprising and stored in the memory to:
identify when a repair of the identified independent one of the plurality of node controller computing devices with the failure is initiated;
wherein the processor coupled to the memory is further configured to be capable of executing at least one additional programmed instruction for the direct any of the I/O operations to the selected another one of the plurality of node controller computing devices without a failure for servicing and then routing of any of the serviced I/O operations further comprising and stored in the memory to:
halt the servicing of any of the routed I/O operations with the identified independent one of the plurality of node controller computing devices with the failure and with the identified initation of the repair; and
allow buffering of any of the routed I/O operations in the another independent one of the plurality of node controller computing devices for a stored buffer time.

18. The system as set forth in claim 13 wherein the failure comprises a failure of a NVRAM battery failure in one or more of the plurality of node controller computing devices.
